(19) United States
(12) Patent Application Publication
(10) Pub. No.: US 2007/0120282 A1
(43) Pub. Date: May 31, 2007

(54) Method for making matting

(76) Inventor: Robertus W. Covers, Swartz Creek, MI (US)

Correspondence Address: Paul L. Marshall;Delphi Technologies, Inc., P.O. Box 5052, M/C 480-410-202, Troy, MI, 48007-5052, US

(21) Appl. No.: 11/290,343

(22) Filed: Nov. 30, 2005

(51) Int. Cl. B28B 1/26; D21J 3/00

(52) U.S. Cl. 264/87; 264/324; 264/157

(57) ABSTRACT

A method for making matting, wherein the method comprises forming a slurry into an uncured blanket, cutting a desired shape from the uncured blanket to form a mat precursor and uncured excess material, and feeding the uncured excess material into the slurry.

### TECHNICAL FIELD

This disclosure generally relates to exhaust treatment devices and specifically to methods for manufacturing retention and insulating materials.

### BACKGROUND

Various exhaust treatment devices, such as NOx adsorbers, particulate filters, selective catalytic reduction catalysts, oxidation catalysts, and the like, have demonstrated to be effective at remediating undesirable emissions from the exhaust streams produced by internal combustion engines. These devices are capable of converting emissions such as, carbon monoxide (CO), hydrocarbons (HC), nitrogen oxides (NOx), and the like, into more harmless species or compounds by employing a catalytic substrate.

Catalytic substrates (e.g., substrates) are generally fabricated utilizing materials such as, but not limited to, cordierite, silicon carbides, metal oxides, metals, and other materials that are capable of withstanding operating temperatures of about 600° to about 800° Celsius in underfloor applications, and up to about 1,000° Celsius in manifold mounted or close coupled applications. Substrates are designed to comprise a large surface area to increase the effective contact area of the exhaust stream and a catalyst (e.g., platinum) that is disposed thereon. Substrates can be manufactured in many designs, such as, but not limited to, foils, preforms, fibrous materials, monoliths, porous glasses, glass sponges, foams, pellets, particles, and molecular sieves.

Generally, substrates are contained within housing components, which can comprise an outer “shell” that is capped on either end with funnel-shaped “end-cones”. The narrow ends of the end-cones' funnel-shape can be referred to as a “snorkel”, which allows the exhaust treatment device to be connected to exhaust conduit. The housing components can be fabricated of any materials capable of withstanding the temperatures, vibration, corrosion, and wear that is encountered during the operation of the exhaust treatment device. Suitable materials can comprise, but are not limited to, ferrous metals and/or ferritic stainless steels (e.g., martensitic, ferritic, and austenitic stainless materials). Furthermore, the shell and end-cones can be configured to include heat shields or a dual-wall design that can minimize heat loss and reduce temperature of the device's external surfaces. In such designs, insulative materials can be employed to even further increase the housings insulating properties.

The substrate is secured within the shell utilizing matting materials (e.g., mat, matting), which can be disposed between the shell and the substrate. In addition to securing the substrate, the matting also thermally insulates the substrate and provides vibration and shock protection. Matting can exist in the form of a mat, preforms, or the like, and comprise materials such as, intumescent materials (e.g., a material that comprises vermiculite component, i.e., a component that expands upon the application of heat), non-intumescent materials, ceramic materials (e.g., ceramic fibers), organic binders, inorganic binders, as well as combinations comprising at least one of the foregoing materials. Non-intumescent and intumescent mat materials include those sold under the trademarks “INTERAM” by the “3M” Company, Minneapolis, Minn., or those sold under the trademark, “CC-MAX” and “XPE” by the Unifrax Co., Niagara Falls, N.Y., and the like.

Exhaust treatment devices can be assembled utilizing various methods. Three such methods comprise the stuffing, clamshell, and tourniquet assembly methods. The stuffing method generally comprises pre-assembling a die-cut mat support around a substrate, and pushing, or stuffing, the assembly into a shell through a stuffing cone. The stuffing cone serves as an assembly tool that is capable of attaching to one end of the shell. Where attached, the shell and stuffing cone have the same cross-sectional geometry, and along the stuffing cone's length, the cross-sectional geometry gradually tapers to a larger cross-sectional geometry. Through this larger end, the substrate/mat sub-assembly is advanced, which compresses the matting around the substrate, and the substrate/mat sub-assembly is eventually pushed into the shell.

A clamshell assembly method can also be utilized to produce an exhaust treatment device assembly. This method generally comprises pre-assembling a die-cut mat support around the substrate, similar to the stuffing method. Once formed, two mating shell-like halves can be assembled around the substrate/mat sub-assembly and secured (e.g., welded). When assembled, these mating halves comprise the converter shell and can also comprise the end-cones and snorkels.

Another method of assembly is the tourniquet assembly method. In this assembly method as well, a die-cut mat support is pre-assembled around a substrate to form a substrate/mat sub-assembly. Once complete, a steel sheet can be wrapped around the substrate/mat assembly, compressed about the sub-assembly, and fastened at its seam (e.g., welded). When assembled, the steel sheet comprises the device's shell, to which the end cones are attached.

Matting can be cut from a larger sheet, or “blanket”, of material utilizing a die-cutting process. When the geometry of matting is irregular, the die-cutting process can produce a volume of scrap. For example, in insulation applications wherein the matting is to be assembled within end cones and/or heat shields, manufacturers can incur high scrap rates (e.g., about 5 to about 50 weight percent) of matting materials due to the highly irregular shapes required. As a result, the excess material produced burdens manufacturers with high raw material and waste disposal costs. Consequently, manufactures desire methods for manufacturing die-cut matting materials that can reduce or eliminate these expenses. Disclosed herein is a method for producing matting materials that enables manufacturers to reduce these inefficiencies.

### SUMMARY

Disclosed herein are methods for making matting material.

In a first embodiment, a method for making matting is disclosed. The method comprises forming a slurry into an uncured blanket, cutting a desired shape from the uncured blanket to form a mat precursor and uncured excess material, and feeding the uncured excess material into the slurry.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is a process flow chart for an exemplary manufacturing process wherein excess material from the die-cutting process is not recycled and becomes scrap.

FIG. 2 is a process flow chart for an exemplary manufacturing process wherein the excess material from the die-cutting process can be recycled.

### DETAILED DESCRIPTION

Disclosed herein are methods for manufacturing matting materials that comprise recycling uncured excess matting materials produced during manufacturing. More specifically, a method of manufacturing is disclosed wherein uncured matting is die-cut prior to curing, thereby enabling scrap produced during the die-cut process to be re-introduced to the production slurry for the production of additional matting. The method disclosed reduces manufacturing disposal and raw material costs.

The endpoints of all ranges disclosed herein that are directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). Also, the terms “front”, “back”, “bottom”, and/or “top” are used herein, unless otherwise noted, merely for convenience of description, and are not limited to any one position or spatial orientation. The suffix “(s)” as used herein is intended to include both the singular and the plural of the term that it modifies, thereby including one or more of that term (e.g., the metal(s) includes one or more metals).

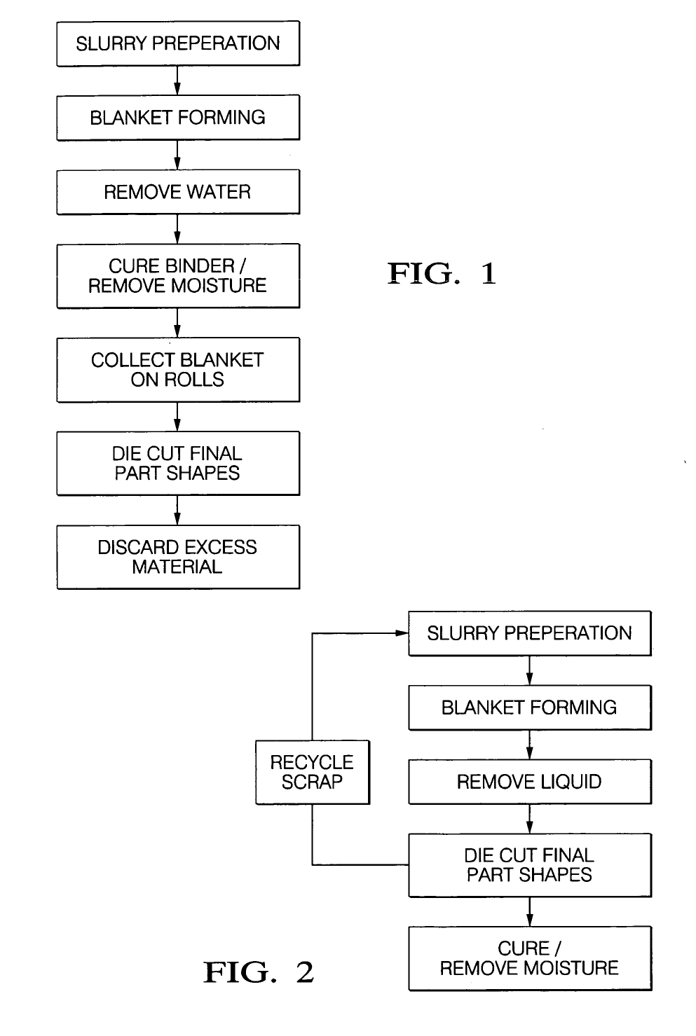

Referring now to FIG. 1, an exemplary process flow chart is illustrated here, wherein scrap materials are produced post cure and therefore are not recycled. In this process, the slurry is prepared, a blanket is formed, and water is removed from the blanket before the blanket is cured. The cured blanket is collected on rolls for a subsequent die cutting process. The cured blanket is die cut to the desired size and shape. Since the material is cured, and due to the irregular shape of the excess blanket pieces, the excess is discarded. As a result, manufacturers realize this inefficiency in the form of disposal and raw material costs.

Referring now to FIG. 2, an exemplary process flow chart is illustrated wherein scrap materials can be recycled. The process comprises slurry preparation and processing. Slurry processing comprises combining of the matting components in a liquid media. The slurry composition can comprise water, processing aids (e.g., pH modifiers, surfactants, thickening agents), and particles, such as, but not limited to, intumescent material(s) (e.g., a material that comprises vermiculite component, i.e., a component that expands upon the application of heat), non-intumescent material(s), ceramic material(s) (e.g., ceramic fibers), binder(s) (e.g., organic binders and/or inorganic binders), reactant(s), filler(s), and so forth, as well as combinations comprising at least one of the foregoing materials. In one embodiment for example, the slurry can comprise an aqueous solution wherein intumescent vermiculite particles, non-intumescent ceramic fibers, and an organic binder (e.g., polymer) are combined.

The slurry can be formulated within a mixing tank. The mixing tank can comprise any volume and geometry capable of producing the slurry. In addition, mixing elements can be employed to agitate and/or mix the slurry. In one embodiment, a mixing tank can be employed that is capable of comprising an internal volume of 1,000 gallons. In addition, an agitator can be introduced to mix the slurry formulation within the tank. It is desirable that the mixing tank and agitator are constructed of materials capable of withstanding wear and corrosion. Materials such as metals, metal alloys (e.g., martensitic, ferritic, and austenitic materials), and the like, can be employed.

Once formulated, the slurry can be formed into an uncured blanket within a forming machine, which is also capable of removing at least a portion of the water from the uncured blanket formed. The forming machine can comprise any apparatus capable of forming the uncured blanket. For example, in one embodiment, a forming machine comprises a hopper through which the slurry can be fed, pumped through a slurry-pump, and introduced into a forming apparatus, e.g., similar to a paper making machine. Adjustable compression rollers that roll over the surface of the uncured blanket exert compression forces thereon to affect the blanket's final thickness and density.

The uncured blanket can be weak, especially if it contains a high volumetric percentage of liquids (e.g., about 5 vol. % to about 60 vol. %). Therefore, the handling equipment employed should be capable of supporting the uncured blanket and minimizing stresses imparted thereon during handling. Drying the uncured blanket can improve the blanket's strength. Therefore, an additional drying process can be employed to remove excess liquids (e.g., water). Any processes capable of removing liquids without curing any binders within the blanket can be used. For example, the blanket can be conveyed over an additional forming drum, wherein a vacuum can be employed to pull additional liquids (e.g., water) from the uncured blanket. In another embodiment, the uncured blanket can be passed through a drying oven that can be operated at a temperature that does not initiate curing of the binders, but can drive off liquids.

Once formed and optionally dried, the uncured blanket can be cut into mat precursors comprising the desired shape. The mat precursors can be cut utilizing any method, such as, but not limited to, an indexing press, a rotary die-cutting machine, a transfer press, and a combination comprising at least one of the foregoing. In an exemplary indexing operation, a gap can be disposed between and first transfer belt and second transfer belt, wherein the gap is disposed after the die cutting process. The gap between the belts can be dimensioned to allow the excess material to fall therethrough so it can be reintroduced to the slurry, while vacuum assist is used to hold the mat precursors in their cavity until they are able to pass onto the successive transfer belt and to a curing process. Alternatively, a vacuum suction system (that optionally comprises a water spray assist) can be employed to separate and remove the excess material from the mat precursors. Thereafter, the scrap can be stripped from the drum and reintroduced to the slurry, and the mat precursors can be advanced to a curing process. Optionally, if the blanket shrinks during curing, the degree of shrinkage can be taken into account and the mat precursors can be cut to account for the shrinkage.

The excess blanket material produced in the die-cutting process can be collected and recycled back to the slurry since it is not yet been cured. Optionally, the uncured excess material can be reduced in size or broken-down prior to introduction to the slurry. In one example, the uncured material can be fed through grinder(s), cutter(s), and/or granulator(s), and so forth, which produces, for example, ground uncured blanket granules equal to or less than one-quarter inch in diameter. In another example, the uncured blanket can be fed through mixing screw(s), and/or extruder(s), and so forth, capable of reducing the size of the uncured excess material and conveying the reduced material to the mixing tank.

The mat precursors can then be heated to cure any binders therein. The heating process drives off any remaining moisture and cures the binders within the blanket, thereby binding the matting's network of fibers and particles together. Any furnace can be utilized for the heating process, such as furnace configured to convey the mat precursors through a ventilated heating zone that exits to a cooling zone. It is also desirable that the furnace is capable of maintaining temperatures that can efficiently cure any binder employed. In one example, a mat comprising an organic binder can be heated in a furnace to remove moisture and cure the binder. For example, a sodium silicate binder can be employed, wherein a furnace set at a temperature of greater than or equal to about 700° Fahrenheit (F) (371° C.), or more specifically, greater than or equal to about 750° F. (400° C.). In addition, the furnace can be configured with any method and/or elements for heating, such as infrared quartz heating elements configured in conjunction with a convection fan to improve the efficiency of displacing evaporated water. Once cured, the matting components can be cooled and packaged.

The proposed process cuts the uncured blanket into mat precursors comprising the desired shape prior to curing the binder. As a result, excess uncured blanket can be recycled back to the slurry for further production, thereby reducing costs and enhancing efficiency of the mat process.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for making matting, comprising:
forming a slurry into an uncured blanket;
cutting a desired shape from the uncured blanket to form a mat precursor and uncured excess material;
feeding the uncured excess material into the slurry; and
curing the mat precursor.

2. The method of claim 1, further comprising removing liquid from the uncured blanket.

3. The method of claim 1, further comprising reducing the size of the uncured excess material.

4. The method of claim 1, wherein cutting the desired shape further comprises accounting for shrinkage during cure.

5. The method of claim 1, further comprising retaining the mat precursor against cavities in a drum with a vacuum assist and passing the uncured excess material through a gap.

6. The method of claim 5, wherein the uncured blanket is cut with a device selected from the group consisting of rotary die cutting machine, an indexing press, a transfer press, and a combination comprising at least one of the foregoing.

7. The method of claim 1, further comprising removing the uncured excess material with vacuum suction.

8. The method of claim 7, further comprising assisting the vacuum suction with a water spray.

9. The method of claim 7, wherein the uncured blanket is cut with a device selected from the group consisting of rotary die cutting machine, an indexing press, a transfer press, and a combination comprising at least one of the foregoing.

10. A method for making matting, consisting of:
forming a slurry;
forming the slurring into an uncured blanket;
removing liquid from the uncured blanket;
cutting a desired shape from the uncured blanket to form a mat precursor and an uncured excess material;
processing the uncured excess material; and
curing the mat precursor.

11. The method of claim 10, wherein processing the uncured excess material comprises reducing the size of the uncured excess material and introducing the uncured excess material into the slurry.

12. The method of claim 11, wherein reducing the size of the uncured excess material comprises grinding the uncured excess material and introducing the ground excess material into the slurry.

13. The method of claim 10, wherein the uncured blanket is cut with a device selected from the group consisting of rotary die cutting machine, an indexing press, a transfer press, and a combination comprising at least one of the foregoing.

14. The method of claim 10, wherein processing the uncured excess material comprises retaining the mat precursor against cavities in a drum with a vacuum assist and passing the uncured excess material through a gap.

15. The method of claim 10, wherein processing the uncured excess material comprises removing the uncured excess material with vacuum suction.

16. The method of claim 10, wherein processing the uncured excess material comprises removing the uncured excess material with vacuum suction with a water spray.

17. A method for making matting, consisting of:
forming a slurring into an uncured blanket;
removing liquid from the uncured blanket;
cutting a desired shape from the uncured blanket to form a mat precursor and an uncured excess material, wherein the uncured blanket is cut with a device selected from the group consisting of rotary die cutting machine, an indexing press, a transfer press, and a combination comprising at least one of the foregoing;
retaining the mat precursor against cavities in a drum with a vacuum assist;
passing the uncured excess material through a gap;
reducing the size of the uncured excess material;
introducing the uncured excess material into the slurry; and
curing the mat precursor.

18. A method for making matting, consisting of:
forming a slurring into an uncured blanket;
removing liquid from the uncured blanket;
cutting a desired shape from the uncured blanket to form a mat precursor and an uncured excess material, wherein the uncured blanket is cut with a device selected from the group consisting of rotary die cutting machine, an indexing press, a transfer press, and a combination comprising at least one of the foregoing;
removing the uncured excess material with vacuum suction with a water spray;
reducing the size of the uncured excess material;
introducing the uncured excess material into the slurry; and
curing the mat precursor.
